(19) United States
(12) Patent Application Publication
(10) Pub. No.: US 2006/0063911 A1
(43) Pub. Date: Mar. 23, 2006

(54) Enhanced scratch resistance of articles containing a combination of nano-crystalline metal oxide particles, polymeric dispersing agents, and surface active materials

(76) Inventors: Roger H. Cayton, Plainfield, IL (US); Murray Patrick, Yorksville, IL (US); Petra Lenz, Wesel (DE); Klaus Schulte, Wesel (DE); Martin Grundkemeyer, Wesel (DE); Thomas Sawitowski, Wesel (DE)

Correspondence Address: WILDMAN HARROLD ALLEN & DIXON, 225 WEST WACKER DRIVE, SUITE 2800, CHICAGO, IL, 60606, US

(21) Appl. No.: 11/139,967

(22) Filed: May 27, 2005

Related U.S. Application Data
(60) Provisional application No. 60/574,907, filed on May 27, 2004.

(51) Int. Cl. C08G 65/34

(52) U.S. Cl. 528/425

(57) ABSTRACT

A film forming composition comprises a resin, a plurality of nanoparticles, a surface active material and a polymeric dispersant. The film forming composition is substantially transparent and is adapted to be combined with a substrate to enhance abrasion resistance. The film forming composition may be used with wood objects including furniture, doors, floors, for architectural surfaces, for automotive articles and finishes, for metal coatings and coil coatings, for plastic articles, and for wipe-on protective treatments.

### PRIORITY

This application is entitled to the benefit of and claims priority to U.S. App. Ser. No. 60/574,907, filed May 27, 2004, the entirety of which is hereby incorporated by reference.

### TECHNICAL FIELD

The present invention relates to film forming compositions, and more particularly to nanoparticle-based additives used with film forming compositions to enhance scratch resistance. Typical film forming compositions include polymer-based coatings applied to substrates to protect the substrate from scratching, but polymeric articles manufactured by cold cure, extrusion, co-extrusion, or molding techniques may also benefit from this technology. Often these coatings and/or polymeric articles are transparent.

### BACKGROUND

Prior art cites two methods to improve the scratch resistance of polymeric coatings, (1) using additives to increase the surface slip of the coating (Method 1), or (2) incorporating ceramic particles to increase the hardness to the coating (Method 2).

Method 1 incorporates additives, such as silicones, waxes, or fluorinated materials, into a coating to lower the surface energy of the coating and increase surface slip. These additives can, in some formulations, decrease the tendency for a coating to scratch, but the surface hardness of the coating is not substantially changed and increase in scratch resistance is limited.

Method 2 incorporates inorganic or ceramic particles to improve the scratch resistance of a coating. The incorporation of such ceramic particles can substantially improve the scratch resistance of the coating, but other properties of the coating are often sacrificed—such as an undesirably large increase in haze, or undesirable changes in physical properties (viscosity, modulus, flexibility, etc.).

In transparent articles and coatings, the use of nanoparticle compositions to enhance scratch resistance may also result in undesirably high haze. The high haze occurs because light scatters from large particles or particle aggregates, the high refractive index mismatch between nanoparticle and matrix, high nanoparticle concentrations, or a combination of these properties associated with nanoparticles. For example, silicon dioxide and aluminosilicate particles are commonly used to enhance the scratch resistance of transparent coatings because the refractive index of such particles matches closely to that of many coating formulations, preventing an undesirable increase in haze regardless of particle size or degree to which particles are dispersed. However, high concentrations of silicon dioxide particles are typically required to provide scratch resistance and this high silicon dioxide concentration can lead to undesirable changes in other properties such as formulation viscosity. Aluminum oxide particles can provide greater scratch resistance than silicon dioxide particles, but the high refractive index of such aluminum oxide results in substantial light scattering and haze compared to lower refractive index particles of the same size, limiting the concentration that can be used to below that required to achieve optimum scratch resistance.

There is a need for a nanoparticle-based additive that enhances the scratch resistance of film forming compositions, without attendant sacrifices in other properties of said compositions, including transparency, optical clarity, viscosity, flexibility, etc.

### INVENTION SUMMARY

The present invention concerns an improved nanoparticle-based additive, adapted to enhance the scratch resistance of film forming compositions.

Briefly, the present invention comprises a combination of polymeric dispersing agent with a surface active material and nanoparticles. In one embodiment, the present invention may provide relatively higher levels of scratch resistance of articles, such as bulk polymer articles and polymeric coatings. In another embodiment, the nanoparticle-based additives may be incorporated into film forming compositions at relatively low nanoparticle concentrations, such as 0.5% to about 10% by weight of the composition, without substantial alteration of other properties of the composition, such as transparency, gloss, viscosity, flexibility, and modulus. In still another embodiment, at least one of the plurality of nanoparticles may be positioned at a surface of the film forming composition or a surface of substrate comprising the film forming composition.

Also provided herein are methods for enhancing scratch resistance, comprising the steps of providing a film forming composition, applying the film forming composition to a substrate exhibiting a first abrasion resistance, and adding an abrasion resistance modifier to the substrate or the film forming composition, the modifier comprising a plurality of metal oxide-based nanoparticles, a polymeric dispersing agent and a surface active material, wherein the substrate, after the adding step, exhibits a second abrasion resistance greater than the first abrasion resistance.

The present invention also relates to methods for forming a film forming composition comprising the steps of providing nanocrystalline particles, mixing the nanocrystalline particles with a polymeric dispersant to form a dispersion comprising a plurality of un-agglomerated primary nanocrystalline particles, lowering the surface tension or surface energy of the dispersion, adding the dispersion to a resin to form a film forming composition, applying the film forming composition to a substrate, and forming a substantially transparent film on the substrate. The film forming composition may be used with various substrates including metal, plastic or wood objects, such as automobiles furniture and architectural surfaces.

### DETAILED DESCRIPTION

The nanoparticle-based additive of the present invention comprises a novel combination of nanoparticles, polymeric dispersing agents, and a surface active material in the polymeric article or formulation. Nanoparticles, especially substantially spherical nanocrystalline metal oxides, are incorporated into the formulation to increase the hardness of the polymeric-based article or coating. The polymeric dispersing agents help disperse the nanoparticles to their primary particle size and may prevent the nanoparticles from agglomerating during formulation and processing. The surface active material typically interacts with the polymeric dispersing agents and the nanoparticle surfaces to enhance the scratch resistance of polymeric coatings and may enable the migration of the nanoparticles to either the surface of the article or coating, or the interface between the article or coating and another material.

This invention is advantageous because the constituents in the nanoparticle-based additive not only provide synergistic results with respect to enhanced scratch resistance but, in certain embodiments, also avoid substantial alteration of other properties of the article or coating such as transparency, gloss, modulus, flexibility, or viscosity.

In other embodiments, the combination of nanoparticles, polymeric dispersing agents, and a surface active material allows the use of lower concentrations of nanoparticles in the article or coating for enhanced scratch resistance, which in turn, provides for higher transparency or optical clarity in the article or coating compared with formulations in which one or more of the components of the invention (nanoparticles, polymeric dispersing agents, and surface active material) is removed. The economic advantage becomes great and enables better performing material systems to be developed. In these embodiments, the nanoparticle concentration range, with respect to the weight of the film forming composition may be between about 0.1 to about 50 wt % and more particularly between about 0.10 to about 20 wt % and between about 0.1 to about 10 wt %.

The nanoparticles, especially substantially spherical nanocrystalline metal oxide particles, may include materials characterized by dimensions substantially less than 100 nm for the longest aspect of the particle, and having a crystalline non-porous structure, with suitable examples of such metals comprising silicon, aluminum, titanium, zinc, boron, copper, ceria, zirconium, iron, tin, antimony, indium, magnesium, calcium, silver, or combinations thereof. The term nanoparticle, as used herein, means any particle including a diameter of less than 100.0 nm for the longest aspect of the particle.

Polymeric dispersing agents refer to materials designed to promote the dispersion and stabilization of solid particles in fluids or polymers, especially substantially spherical nanocrystalline metal oxides.

In non-aqueous media, the polymeric dispersing agents found to be very effective at yielding substantially stable dispersions of substantially spherical nanocrystalline metal oxides are comprised of polymeric chains (molecules with repeating backbone units) and feature one or more anchor groups. In general, a stable dispersion of substantially spherical nanocrystalline metal oxides and non-aqueous media is formed using (1) polymeric dispersants having molecular weight greater than 1000, and (2) one or more acidic or basic anchoring groups that interact with the metal oxide surface. In general, both homopolymers and copolymers can be effective dispersants for nanocrystalline metal oxides. Additionally, these homopolymers and copolymers may be soluble in the non-aqueous media.

In aqueous media, water-soluble copolymers that have polymer segments that are attractive to the nanocrystalline particle and polymer segments that render them water-soluble were found to be effective polymeric dispersing agents capable of yielding substantially stable dispersions of substantially spherical nanocrystalline metal oxides. The copolymeric dispersant may anchor to the nanoparticle surface through at least one of acidic interactions, basic interactions, neutral interactions, and covalent interactions. The interaction between the copolymeric dispersant and the at least one of the nanoparticles may be one of cationic character, anionic character, and neutral character.

However, for both aqueous and non-aqueous media, polymeric dispersing agents found to be effective at yielding substantially stable dispersions of substantially spherical nanocrystalline metal oxides generally (1) include molecular weight greater than 1000, (2) include one or more anchor groups with acidic, basic, neutral, or covalent interaction, and (3) are soluble in the dispersing media.

Suitable examples of polymeric dispersing agents comprise certain polyacrylates, polyesters, polyamides, polyurethanes, polyimides, polyurea, polyethers, polysilicones, fatty acid esters, as well as amine, alcohol, acid, ketone, ester, fluorinated, and aromatic functionalized versions of the previous list, and physical blends and copolymers of the same. Polymeric dispersing agents, with respect to the weight of nanoparticle, may be present in an amount between about 0.5 and about 50 wt %, more particularly between about 1.0 and about 40 wt %, and about 2.0 and about 30.0 wt %.

Surface active additives refer to any material which tends to lower the surface tension or surface energy of the article. Suitable examples of surface active materials include certain sulfonates, sulfates, phosphates, alkyl amine salts, polyacrylates (homo and copolymers), ethylene oxide and propylene oxide polymers and block copolymers, polysiloxanes, organically-modified polysiloxanes, fluorinated small molecules, fluorinated polymers and copolymers, natural or artificial waxes, and physical blends or covalently bonded copolymers of the above. The surface active material, with respect to the weight of nanoparticle may be present in an amount between about 0.1 and about 50.0 wt %, more particularly between about 0.2 and 20 wt %, and between about 0.5 and about 10 wt %.

Although there may appear to be a chemical overlap between the polymeric dispersing agent and the surface active material they are distinctly different elements of this invention. The purpose of the dispersant is to yield a substantially stable dispersion of particles, in particular, the substantially spherical nanocrystalline metal oxides, in the formulation. The surface active material interacts with the polymeric dispersing agents and the nanoparticle surfaces, lowering the surface tension or surface energy of the article or formulation. The surface active material may also enable the migration of the nanoparticles to either the surface of the article or coating, or the interface between the article or coating and another material.

The types of articles or coatings in which the scratch resistance can be enhanced through application of this invention include any material which may be formulated with a dispersion of nanoparticles, polymeric dispersing agents, and a surface active material. Typically these articles include cross-linked and uncross-linked polymeric systems. Examples of polymeric coatings comprise polyether, polyurethane, epoxy, polyamide, melamine, acrylate, polyolefin, polystyrene, and fluorinated polymer resins as well as copolymers and blends of said polymer and copolymer resins. These resins may be formulated into water-borne, water-soluble, emulsion, or solvent-borne coatings, as well as solvent-free 100% solids coatings. Examples of commercially important coatings include, but are not limited to, protective coatings: for wood objects including furniture, doors, floors, and architectural surfaces; for automotive articles and finishes; for metal coatings and coil coatings; for plastic articles; and for wipe-on protective treatments.

The scratch resistance of an article or substrate comprising the film forming composition of the present invention may be measured as % gloss retention or a scratch resistance parameter.

The term % gloss retention, as used herein, means the final gloss of an article divided by the initial gloss of the article times 100, where initial and final gloss are measured by a BYK-Gardner Haze-Gloss instrument—20° gloss measured parallel to scratch direction. The final gloss of the article is determined by subjecting the article to an abrasive implement, such as steel wool, a Scotch Brite pad or the like. The % gloss retention reflects the scratch resistance of the article because surface scratches reduce gloss. Scratch resistance is greater at higher % GR values.

The term scratch resistance parameter, as used herein, means the haze increase of a substrate without the film forming composition of the present invention divided by the haze increase of a substrate comprising the film forming composition of the present invention, as measured by BYK-Gardner Haze-Gard Plus instrument. Haze increase is measured by calculating the difference between the transmitted haze of the substrate before and after a scratch test is administered. A scratch resistance parameter of 1.0 indicates no improvement in scratch resistance with respect to the control in each example. The higher the SRP measured, the greater the enhancement of the scratch resistance for the film. The scratch resistance parameter of a substrate comprising the film forming composition of the present invention may be greater than shown previously; testing shown in the following examples yields scratch resistance parameter values of about 4 and more particularly between about 2.5 and about 20, depending on the composition of the claimed elements. However these scratch resistance values are recognized to be dependent on composition of the elements and the abrasiveness of the implement used to conduct the scratch test.

The use of a combination of a surface active material, a polymeric dispersing agent, and a nano-crystalline metal oxide to enhance scratch resistance of an article is novel and non-obvious to those skilled in the art. Removal of any one of the three components of the invention diminishes the effectiveness of the invention as the following examples illustrate.

### INVENTION EXAMPLES

The present invention is illustrated, but in no way limited by the following examples:

Steel Wool Scratch Test Procedure: For Examples 1-3, films were tested for scratch resistance by subjecting each to 200 double rubs with a 0 grade 2″×2″ steel wool pad, and measuring the increase in transmitted haze resulting from the scratches on a BYK-Gardner Haze-Gard Plus instrument. A pressure of 40 g/cm² was applied to the steel wool pad. For Example 4, a pressure of 8 g/cm² was applied to the steel wool pad and 50 double rubs were used. The scratch resistance of each film was quantified in terms of the suppression of haze resulting from scratching. A Scratch Resistance Parameter (SRP) was calculated by dividing the haze increase measured for the neat film (film A in each example) by the haze increase measured for the other films in the same example. A SRP of 1.0 indicates no improvement in scratch resistance with respect to the control in each example. The higher the SRP measured, the greater the enhancement of the scratch resistance for the film.

Nylon Brush Scratch Test Procedure: For Examples 5 and 7, films were tested for scratch resistance by subjecting UV-curable coatings to 500-1000 double rubs and solvent-borne coatings to 100 double rubs with a nylon brush using a BYK Gardner Scrub Tester. Coating gloss before and after nylon brush rubs was measured on a BYK-Gardner Haze-Gloss instrument—20° gloss measured parallel to scratch direction. The % gloss retention, % GR (final gloss/initial gloss×100), reflects the scratch resistance of the coating because surface scratches reduce gloss. Scratch resistance is greater at higher % GR values.

The Scotch Brite Scratch Test Procedure: For Example 6, films were tested for scratch resistance by subjecting each to 10 double rubs of the coating with a Scotch Brite pad under 100 g/cm² pressure, and measuring the change in gloss on a BYK-Gardner Haze-Gloss instrument—20° gloss measured parallel to scratch direction. The % gloss retention, % GR (final gloss/initial gloss×100), reflects the scratch resistance of the coating since surface scratches reduce gloss. Scratch resistance is greater at higher % GR values.

The severity of abrasion testing depends on the wear surface (Scotch Brite, Steel Wool, Nylon Brush), the applied pressure, and the number of times the wear surface rubs the surface being tested. Under the conditions given for the above tests, the Steel Wool Abrasion Test and Scotch Brite Abrasion Test apply the greatest degree of abrasion to surfaces and simulate rough contact wear. The Nylon Brush Abrasion Test applies a lower degree of abrasion and simulates a car wash.

### Example 1

A UV-curable urethane-based coating formulation comprising 30 wt % Sartomer SR-368, 30 wt % Sartomer CD-501, 30 wt % Sartomer SR-238, and 10 wt % Sartomer SR-494 was prepared and to this composition was added 5 wt % benzophenone and 5 wt % Irgacure 651 as curing agents. Aluminum oxide nanoparticles were dispersed at 30 wt % in Sartomer SR-238 using a polymeric dispersing agent and surface active material of the source and concentration listed in the table below. All concentrations are expressed in wt % with respect to total resin solids in the coating. These dispersions were added to the UV-curable formulation, stirred thoroughly, and used to prepare 1 mil films on glass slides. The films were cured by UV radiation at 0.6 joules/pass for three passes. Each of the cured films was tested for initial haze, and for SRP as defined in the Steel Wool Scratch Test Procedure above.

| | A | B | C | D | E | F | G |
|---|---|---|---|---|---|---|---|
| Al₂O₃, wt %¹ | 0.0 | 0.0 | 0.0 | 1.0 | 2.0 | 1.0 | 2.0 |
| Solsperse 32000, %² | 0.00 | 0.00 | 0.00 | 0.07 | 0.14 | 0.05 | 0.09 |
| BYK UV 3500, %³ | 0.00 | 0.20 | 0.40 | 0.00 | 0.00 | 0.03 | 0.05 |
| Initial Haze, % | 0.04 | 0.04 | 0.06 | 0.31 | 0.56 | 0.42 | 0.73 |
| SRP | 1.0 | 1.1 | 0.9 | 2.0 | 3.4 | 4.4 | 8.8 |

¹NanoDur ™ aluminum oxide from Nanophase Technologies Corp., 45 m²/g.
²Avecia (polymeric dispersing agent)
³BYK Chemie (surface active material)

Example 1A is the base coating formulation. Examples 1B-1E are coating formulations in which one or more elements of the present invention are removed. Examples 1F-1G are coating formulations of the present invention. The 1B and 1C formulations contain a surface active material but no nanoparticles or polymeric dispersing agent. As a result, the 1B and 1C SRP show no improvement compared with 1A. The 1D and 1E formulations contain nanoparticles and a polymeric dispersing agent, but no surface active material. As a result, the 1D and 1E SRP is only somewhat improved compared with the base formulation, 1A. The 1F and 1G formulations contain nanoparticles, a polymeric dispersing agent, and a surface active material and embody the present invention. The 1F and 1G SRP are substantially improved compared with 1A-1E.

### Example 2

A UV-curable epoxy-based coating formulation comprising 30 wt % Sartomer CN-120, 30 wt % Sartomer CD-501, 30 wt % Sartomer SR-238, and 10 wt % Sartomer SR-494 was prepared and to this composition was added 5 wt % benzophenone and 5 wt % Irgacure 651 as curing agents. Aluminum oxide nanoparticles were dispersed at 30 wt % in Sartomer SR-238 using the polymeric dispersing agent and surface active material of the source and concentration listed in the table below. All concentrations are expressed in wt % with respect to total resin solids in the coating. These dispersions were added to the UV-curable formulation, stirred thoroughly, and used to prepare 1 mil films on glass slides. The films were cured by UV radiation at 0.6 joules/pass for three passes. Each of the cured films was tested for initial haze, and for its SRP as defined in the Steel Wool Scratch Test Procedure above.

| | A | B | C |
|---|---|---|---|
| Al₂O₃, wt %¹ | 0.0 | 1.0 | 1.0 |
| Solsperse 32000, %² | 0.00 | 0.07 | 0.05 |
| BYK UV 3500, %³ | 0.00 | 0.00 | 0.03 |
| Initial Haze, % | 0.03 | 0.36 | 0.39 |
| SRP | 1.0 | 2.5 | 5.2 |

¹NanoDur ™ alumina from Nanophase Technologies Corp., 45 m²/g.
²Avecia (polymeric dispersing agent)
³BYK Chemie (surface active material)

Example 2A is the base coating formulation. Example 2B is a coating formulation in which one or more elements of the present invention is removed. Example 2C is a coating formulation of the present invention. The 2B formulation contains nanoparticles and a polymeric dispersing agent, but no surface active material. As a result, the 2B SRP is only somewhat improved compared with the base formulation, 2A. The 2C formulation contains nanoparticles, a polymeric dispersing agent, and a surface active material and embodies the present invention. The 2C SRP is substantially improved compared with 2A and 2B.

### Example 3

A thermoset coating formulation comprising 25 wt % Cymel 301, 25 wt % Tone 200, and 50 wt % butyl cellosolve was prepared and to this composition was added 2 wt % of a 20 wt % solution of p-toluenesulfonic acid in 2-propanol as a curing agent. Aluminum oxide nanoparticle dispersions were prepared at 30 wt % in Dowanol PMA using a polymeric dispersing agent and surface active material of the source and concentration listed in the table below. All concentrations are expressed in wt % with respect to total resin solids in the coating. These dispersions were added to the thermoset formulation, stirred thoroughly, and used to prepare 2 mil wet films on glass slides. The films were cured at 120° C. for 1 hour. Each of the cured films was tested for initial haze, and for its SRP as defined in the Steel Wool Scratch Test Procedure above.

| | A | B | C | D | E | F | G | H | I | J |
|---|---|---|---|---|---|---|---|---|---|---|
| Al₂O₃, wt %¹ | 0.0 | 1.0 | 1.0 | 1.0 | 1.0 | 1.0 | 1.0 | 1.0 | 1.0 | 1.0 |
| Solsperse 32000, %² | 0.00 | 0.07 | 0.05 | 0.05 | 0.05 | 0.05 | 0.05 | 0.05 | 0.05 | 0.05 |
| BYK 306, %³ | 0.00 | 0.00 | 0.02 | 0.00 | 0.00 | 0.00 | 0.00 | 0.00 | 0.00 | 0.00 |
| BYK 373, %³ | 0.00 | 0.00 | 0.00 | 0.02 | 0.00 | 0.00 | 0.00 | 0.00 | 0.00 | 0.00 |
| BYK 375, %³ | 0.00 | 0.00 | 0.00 | 0.00 | 0.02 | 0.00 | 0.00 | 0.00 | 0.00 | 0.00 |
| Silclean 3700, %³ | 0.00 | 0.00 | 0.00 | 0.00 | 0.00 | 0.02 | 0.00 | 0.00 | 0.00 | 0.00 |
| Tego Glide 432, %⁴ | 0.00 | 0.00 | 0.00 | 0.00 | 0.00 | 0.00 | 0.02 | 0.00 | 0.00 | 0.00 |
| Glide ZG400, %⁴ | 0.00 | 0.00 | 0.00 | 0.00 | 0.00 | 0.00 | 0.00 | 0.02 | 0.00 | 0.00 |
| Perenol S83 UV, %⁵ | 0.00 | 0.00 | 0.00 | 0.00 | 0.00 | 0.00 | 0.00 | 0.00 | 0.02 | 0.00 |
| Fluorad FC 4432, %⁶ | 0.00 | 0.00 | 0.00 | 0.00 | 0.00 | 0.00 | 0.00 | 0.00 | 0.00 | 0.02 |
| Initial Haze, % | 0.08 | 0.68 | 0.46 | 0.59 | 0.53 | 1.37 | 0.57 | 0.56 | 0.55 | 0.58 |
| SRP | 1.0 | 2.1 | 2.5 | 3.4 | 3.3 | 2.8 | 4.6 | 3.6 | 7.9 | 2.6 |

¹NanoDur ™ alumina from Nanophase Technologies Corp., 45 m²/g.
²Avecia (polymeric dispersing agent)
³BYK Chemie (surface active material)
⁴Degussa (surface active material)
⁵Cognis (surface active material)
⁶3M (surface active material)

Example 3A is the base coating formulation. Example 3B is a coating formulation in which one or more elements of the present invention is removed. Examples 3C-3J are coating formulations of the present invention. The 3B formulation contains nanoparticles and a polymeric dispersing agent, but no surface active material. As a result, the 2B SRP is only somewhat improved compared with the base formulation, 3A. The 3C-3J formulations contain nanoparticles, a polymeric dispersing agent, and a surface active material and embody the present invention. The 3C-3J SRP is substantially improved compared with 3A and 3B.

### Example 4

A two component polyurethane coating formulation comprising 80 wt % HC-7600S Acrylic and 20 wt % HC-7605S Diisocyanate (DuPont) was prepared which contained 40 wt % resin solids. Aluminum oxide nanoparticle dispersions were prepared at 30 wt % in Dowanol PMA using the polymeric dispersing agent and surface active material of the source and concentration listed in the table below. All concentrations are expressed in wt % with respect to total resin solids in the coating. These dispersions were added to the polyurethane formulation, stirred well, and used to prepare 2 mil wet films on glass slides. The films were cured at 120° C. for 1 hour. Each of the cured films was tested for initial haze, and for its SRP as defined in the Steel Wool Scratch Test Procedure above.

| | A | B | C | D | E | F | G | H | I | J | K |
|---|---|---|---|---|---|---|---|---|---|---|---|
| Al₂O₃, wt %¹ | 0.0 | 1.0 | 1.0 | 1.0 | 1.0 | 1.0 | 1.0 | 1.0 | 1.0 | 1.0 | 1.0 |
| Solsperse 32000, %² | 0.0 | 7.0 | 5.0 | 5.0 | 5.0 | 5.0 | 5.0 | 5.0 | 5.0 | 5.0 | 5.0 |
| BYK 375, %³ | 0.0 | 0.0 | 2.0 | 0.0 | 0.0 | 0.0 | 0.0 | 0.0 | 0.0 | 0.0 | 0.0 |
| Silclean 3700, %³ | 0.0 | 0.0 | 0.0 | 2.0 | 0.0 | 0.0 | 0.0 | 0.0 | 0.0 | 0.0 | 0.0 |
| Tego Glide 432, %⁴ | 0.0 | 0.0 | 0.0 | 0.0 | 2.0 | 0.0 | 0.0 | 0.0 | 0.0 | 0.0 | 0.0 |
| Glide ZG400, %⁴ | 0.0 | 0.0 | 0.0 | 0.0 | 0.0 | 2.0 | 0.0 | 0.0 | 0.0 | 0.0 | 0.0 |
| Perenol S83 UV, %⁵ | 0.0 | 0.0 | 0.0 | 0.0 | 0.0 | 0.0 | 2.0 | 0.0 | 0.0 | 0.0 | 0.0 |
| Zonyl FSO-100, %⁶ | 0.0 | 0.0 | 0.0 | 0.0 | 0.0 | 0.0 | 0.0 | 2.0 | 0.0 | 0.0 | 0.0 |
| Zonyl FSN-100, %⁶ | 0.0 | 0.0 | 0.0 | 0.0 | 0.0 | 0.0 | 0.0 | 0.0 | 2.0 | 0.0 | 0.0 |
| Fluorad FC 4430, %⁷ | 0.0 | 0.0 | 0.0 | 0.0 | 0.0 | 0.0 | 0.0 | 0.0 | 0.0 | 2.0 | 0.0 |
| Fluorad FC 4432, %⁷ | 0.0 | 0.0 | 0.0 | 0.0 | 0.0 | 0.0 | 0.0 | 0.0 | 0.0 | 0.0 | 2.0 |
| Initial Haze, % | 0.21 | 0.55 | 0.61 | 0.72 | 0.50 | 0.67 | 0.57 | 0.65 | 0.58 | 0.70 | 0.65 |
| SRP | 1.0 | 1.6 | 2.0 | 2.4 | 2.3 | 2.9 | 4.3 | 2.6 | 2.3 | 1.9 | 2.3 |

¹NanoDur ™ alumina from Nanophase Technologies Corp., 45 m²/g.
²Avecia (polymeric dispersing agent)
³BYK Chemie (surface active material)
⁴Degussa (surface active material)
⁵Cognis (surface active material)
⁶DuPont (surface active material)
⁷3M (surface active material)

Example 4A is the base coating formulation. Example 4B is a coating formulation in which one or more elements of the present invention is removed. Examples 4C-4K are coating formulations of the present invention. The 4B formulation contains nanoparticles and a polymeric dispersing agent, but no surface active material. As a result, the 4B SRP is only somewhat improved compared with the base formulation, 4A. The 4C-4K formulations contain nanoparticles, a polymeric dispersing agent, and a surface active material and embody the present invention. The 4C-4K SRP is substantially improved compared with 4A and 4B.

### Example 5

A proprietary UV-curable coating formulation was prepared in which aluminum oxide nanoparticles (dispersed at 30 wt % in Sartomer SR-238), a polymeric dispersing agent, and a surface active material of the source and concentration listed in the table below were optionally added. All concentrations are expressed in wt % with respect to total resin solids in the coating. The formulations were used to prepare films were cured by UV radiation and the scratch resistance of the films was measured using the nylon brush scratch test procedure above using 500 double rubs with a nylon brush. Each of the cured films was tested for initial gloss, and % GR as defined in the Nylon Brush Scratch Test Procedure above.

| | A | B | C | D | E | F |
|---|---|---|---|---|---|---|
| Al₂O₃, wt %¹ | 0.0 | 0.0 | 2.0 | 3.0 | 2.0 | 3.0 |
| Solsperse 32000, %² | 0.00 | 0.00 | 0.14 | 0.21 | 0.14 | 0.21 |
| BYK UV 3500, %³ | 0.00 | 0.10 | 0.00 | 0.00 | 0.10 | 0.10 |
| Initial Gloss, 20° | 90.0 | 88.0 | 90.3 | 88.7 | 88.4 | 88.7 |
| Final Gloss, 20° | 84.0 | 86.6 | 73.2 | 46.2 | 89.0 | 88.6 |
| % GR | 93.3% | 98.41% | 81.1% | 52.1% | 100.7% | 99.9% |

¹NanoDur ™ aluminum oxide from Nanophase Technologies Corp., 45 m²/g.
²Avecia (polymeric dispersing agent)
³BYK Chemie (surface active material)

Example 5A is the base coating formulation. Examples 5B-5D are coating formulations in which one or more elements of the present invention have been removed. Examples 5E-5F are coating formulations of the present invention. The 5B formulation contains a surface active material but no nanoparticles or polymeric dispersing agent. The 5C and 5D formulations contain nanoparticles and a polymeric dispersing agent but no surface active material. The 5E and 5F formulations contain nanoparticles, a polymeric dispersing agent, and a surface active material and embody the present invention. The 5E and 5F % GR is substantially greater than 5A-5D. In fact, 5E measures greater gloss subsequent to the Nylon Brush Test.

### Example 6

A UV-curable coating formulation containing 43.5 wt % Laromer LR 8986, 43.5 wt % Laromer LR 8967, 8.7 wt % Syloid ED 50, 3.5 wt % Irgacure 184, 0.4 wt % BYK 361, and 0.4 wt % Tego Airex was prepared, and into this aluminum oxide nanoparticles (dispersed at 30 wt % in Sartomer SR-238), a polymeric dispersing agent, and a surface active material of the source and concentration listed in the table below were optionally added. All concentrations are expressed in wt % with respect to total resin solids in the coating. The formulations were used to prepare films that were cured by UV radiation and each of the cured films was tested for initial gloss, and % GR as defined in the Scotch Brite Scratch Test Procedure above.

| | A | B | C | D | E |
|---|---|---|---|---|---|
| Al₂O₃, wt %¹ | 0.0 | 0.2 | 2.0 | 0.2 | 2.0 |
| Solsperse 32000, %² | 0.00 | 0.01 | 0.14 | 0.01 | 0.14 |
| BYK UV 3500, %³ | 0.00 | 0.00 | 0.00 | 0.10 | 0.10 |
| Initial Gloss, 20° | 57.6 | 64.2 | 63.6 | 50.8 | 49.0 |
| Final Gloss, 20° | 26.4 | 37.9 | 39.6 | 45.4 | 40.3 |
| % GR | 45.8% | 59.0% | 62.3% | 89.4% | 82.2% |

¹NanoDur ™ aluminum oxide from Nanophase Technologies Corp., 45 m²/g
²Avecia
³BYK Chemie

Example 6A is the base coating formulation. Examples 6B-6C are coating formulations in which one or more elements of the present invention are removed. Examples 6D and 6E are coating formulations of the present invention. The 6B and 6C formulations contain nanoparticles and a polymeric dispersing agent but no surface active material. The 6D and 6E formulations contain nanoparticles, a polymeric dispersing agent, and a surface active material and embody the present invention. The % gloss retention in 6D and 6E is substantially improved compared with 6A-6C.

### Example 7

A proprietary, two-component aliphatic polyurethane coating formulation was prepared in which aluminum oxide nanoparticles (dispersed at 30 wt % in Dowanol PMA), a polymeric dispersing agent, and a surface active material of the source and concentration listed in the table below were optionally added. All concentrations are expressed in wt % with respect to total resin solids in the coating. These dispersions were added to the polyurethane formulation, stirred well, and used to prepare 2 mil wet films on glass slides. The films were thermally cured at 140° C. for 1 hour. The scratch resistance of the films was measured using the Nylon Brush Scratch Test Procedure described above using 500 double rubs with a nylon brush. The cured films were tested for initial gloss, and for % GR as defined in the Nylon Brush Scratch Test Procedure above.

| | A | B | C | D | E | F | G | H | I |
|---|---|---|---|---|---|---|---|---|---|
| Al₂O₃, wt %¹ | 0.0 | 0.0 | 0.0 | 0.5 | 0.5 | 0.0 | 0.0 | 0.5 | 0.5 |
| Disperbyk-111, %² | 0.00 | 0.00 | 0.00 | 0.10 | 0.10 | 0.00 | 0.00 | 0.10 | 0.10 |
| LP-X-20798, %³ | 0.00 | 0.05 | 0.20 | 0.05 | 0.20 | 0.00 | 0.00 | 0.00 | 0.00 |
| LP-X-20828, %⁴ | 0.00 | 0.00 | 0.00 | 0.00 | 0.00 | 0.05 | 0.20 | 0.05 | 0.20 |
| Initial Gloss, 20° | 86.3 | 85.9 | 85.7 | 86.3 | 86.5 | 86.3 | 86.6 | 87.3 | 85.3 |
| Final Gloss, 20° | 79.1 | 82.0 | 80.5 | 84.3 | 82.0 | 80.8 | 82.8 | 82.2 | 83.9 |
| % GR | 91.7% | 95.4% | 93.9% | 97.7% | 94.8% | 93.6% | 95.6% | 94.2% | 98.4% |

¹NanoArc ™ aluminum oxide from Nanophase Technologies Corp., 95 m²/g
²BYK Chemie - polymeric dispersing agent
³BYK Chemie - reactive linear polysiloxane surface active material
⁴BYK Chemie - reactive comb polysiloxane surface active material

Example 7A represents the base coating formulation, Examples 7B-7C represent coating formulations containing a linear polysiloxane surface active material at 0.05% and 0.20%, no nanoparticles, and no polymeric dispersing agent. Examples 7D and 7E represent coating formulations of the present invention with nanoparticles, a polymeric dispersing agent, and a linear polysiloxane surface active material at 0.05% and 0.20%. Examples 7F-7G represent coating formulations containing a comb polysiloxane surface active material at 0.05% and 0.20%, no nanoparticles, and no polymeric dispersing agent. Examples 7H and 7I represent coating formulations of the present invention with nanoparticles, a polymeric dispersing agent, and a comb polysiloxane surface active material at 0.05% and 0.20%. The % GR in 7D versus 7B, 7E versus 7C, 7H versus 7F, and 7I versus 7G are substantially improved.

### Comparative Example Summary

The following table contains a summary of the Examples. The example number, coating type, scratch resistance test (SR Test), and scratch resistance performance data are compared for the polymer without additives (None), polymer with nanoparticles and polymeric dispersing agent (N+PDA), polymer with polysiloxane surface active material (PSAM), and polymer with nanoparticles and polymeric dispersing agent and polysiloxane surface active material (N+PDA+PSAM). SRP and GRP are the performance data for steel wool and gloss scratch resistance tests, respectively. When multiple tests using different polysiloxane surface active materials are given in the example, the mean values are tabulated. When multiple tests using different levels of nanoparticles are given the wt % of nanoparticles follows the value in parenthesis. No data for a given class is indicated by a hyphen. PU is an abbreviation for polyurethane.

| | Coating | SR | |
|---|---|---|---|
| Example | Type | Test | None/N + PDA/PSAM/N + PDA + PSAM |
| Example 1 | UV-curable urethane | Steel Wool | 1.0/2.0 (1.0)/1.0/4.4 (1.0) |
| | | | 1.0/3.4 (2.0)/1.0/8.8 (2.0) |
| Example 2 | UV-curable epoxy | Steel Wool | 1.0/2.5 (1.0)/—/5.2 (1.0) |
| Example 3 | Thermoset | Steel Wool | 1.0/2.1 (1.0)/—/3.8 (1.0) |
| Example 4 | 2K polyurethane | Steel Wool | 1.0/1.6 (1.0)/—/2.56 (1.0) |
| Example 5 | UV-curable acrylate | Nylon Brush | 93.3%/81.1% (2.0)/98.4%/100.7% (2.0) |
| | | | 93.3%/52.1% (3.0)/98.4%/99.7% (3.0) |
| Example 6 | UV-curable | Scotch Brite | 45.8%/59.0% (0.2)/—/89.4% (0.2) |
| | | | 45.8%/62.3% (2.0)/—/82.2% (2.0) |
| Example 7 | 2K aliphatic PU | Nylon Brush | 91.7%/—/94.6%/96.3% (0.5) |

In the Steel Wool Scratch Resistance Test, the higher the SRP measured, the greater the enhancement of the scratch resistance of the film. From the above table formulations containing nanoparticles and polymeric dispersing agent and polysiloxane surface active material (N+PDA+PSAM)—the formulations of the present invention—have significantly improved scratch resistance.

In the Nylon Brush and Scotch Brite Scratch Resistance Tests, the higher the % GR the greater the enhancement of the scratch resistance of the film. From the above table formulations containing nanoparticles and polymeric dispersing agent and polysiloxane surface active material (N+PDA+PSAM)—the formulations of the present invention—have significantly improved scratch resistance.

The summary table presents abrasion resistance data under a range of abrasion or wear conditions. The Scotch Brite and Steel Wool Abrasion Tests impart severe wear to a surface while the Nylon Brush Abrasion Tests is a mild wear test that simulates a car wash. As such, the degree of protection imparted by the elements of this invention should be viewed in light of the test conditions. In Examples 1-4 and 6 the coating surface experiences relatively heavy or macroscopic wear. Significant abrasion resistance imparted by the film forming composition of the present invention is still observed by haze and gloss measurements, particularly in light of other combinations of materials. In Examples 5 and 7 the coating surface remains intact and coatings which contain only the surface active material retain relatively high gloss because the surface active material operates as a slip agent at the coating surface—since this material is not removed by the test, it retains its function. However, under all wear regimes, the combination of nanoparticles, a polymeric dispersing agent, and a surface active material yield improved wear resistance of commercial value.

Variations, modifications and other implementations of what is described herein will occur to those of ordinary skill in the art without departing from the spirit and scope of the invention. Accordingly, the invention is in no way limited by the preceding illustrative description.

What is claimed:

1. A film forming composition comprising:
a resin;
a dispersion comprising a plurality of nanoparticles, a polymeric dispersant and a surface active material, wherein the film forming composition is substantially transparent and a substrate comprising the film forming composition is substantially abrasion resistant.

2. The film forming composition of claim 1, wherein a substrate comprising the film forming composition exhibits enhanced abrasion resistance, measured as a scratch resistance parameter, between about 2.5 and 20.

3. The film forming composition of claim 1, wherein the resin is selected from the group consisting of polyethers, polyurethanes, epoxies, polyamides, melamines, acrylates, polyolefins, polystyrenes, fluorinated polymer resins and mixtures thereof.

4. The film forming composition of claim 1, wherein the nanoparticles are substantially spherical nanocrystalline metal oxide particles.

5. The film forming composition of claim 1, wherein the nanoparticles are present in an amount between about 0.5% to about 10% by weight of the composition.

6. The film forming composition of claim 1, wherein the nanoparticles are metal oxide nanoparticles and the metal is selected from the group consisting of silicon, aluminum, titanium, zinc, boron, copper, ceria, zirconium, iron, tin, antimony, indium, magnesium, calcium, silver, and mixtures thereof.

7. The film forming composition of claim 1, wherein the polymeric dispersant is selected from the group consisting of polyacrylates, polyesters, polyamides, polyurethanes, polyimides, polyureas, polyethers, polysilicones, fatty acid esters and mixtures thereof.

8. The film forming composition of claim 1, wherein the polymeric dispersant includes a molecular weight greater than 1000 and two or more anchoring groups that interact with a surface of at least one of the nanoparticles.

9. The film forming composition of claim 1, wherein the polymeric dispersant is associated with at least one of the nanoparticles through a covalent interaction.

10. The film forming composition of claim 1, wherein the surface active material is selected from the group consisting of sulfonates, sulfates, phosphates, alkyl amine salts, polyacrylates, ethyelene oxides, propylene oxides and mixtures thereof.

11. The film forming composition of claim 1, wherein the composition exhibits substantially the same optical clarity, gloss or viscosity before and after incorporation of the dispersion.

12. The film forming composition of claim 1, wherein at least one of the plurality of nanoparticles is positioned at a surface of the film forming composition or at a surface of the article.

13. The film forming composition of claim 1, wherein the composition is substantially transparent.

14. A method for enhancing abrasion resistance, the method comprising the steps of:
providing a film forming composition
applying the film forming composition to a substrate, the substrate exhibiting a first abrasion resistance; and
adding an abrasion resistance modifier to the substrate or the film forming composition, the modifier comprising a plurality of metal oxide-based nanoparticles, a polymeric dispersing agent and a surface active material, wherein the substrate, after the adding step, exhibits a second abrasion resistance greater than the first abrasion resistance.

15. The method of claim 14, further comprising the step of dispersing the plurality of metal oxide-based nanoparticles in the polymeric dispersing agent and surface active material prior to the adding step.

16. The method of claim 14, wherein the nanoparticles are substantially spherical.

17. The method of claim 14, wherein the nanoparticles are metal oxide nanoparticles and the metal is selected from the group consisting of silicon, aluminum, titanium, zinc, boron, copper, ceria, zirconium, iron, tin, antimony, indium, magnesium, calcium, silver, and mixtures thereof.

18. The method of claim 14, wherein the nanoparticles are present in an amount between about 0.1% to about 10% by weight of the film forming composition.

19. The method of claim 14, wherein the substrate exhibits substantially the same optical clarity, gloss or viscosity before and after the adding step.

20. The method of claim 14, wherein the film forming composition is substantially transparent after the adding step.

21. A process for forming a film forming composition comprising the steps of:
providing nanocrystalline particles,
mixing the nanocrystalline particles with a polymeric dispersant to form a dispersion comprising a plurality of un-agglomerated primary nanocrystalline particles;
lowering the surface tension or surface energy of the dispersion;
adding the dispersion to a resin to form a film forming composition;
applying the film forming composition to a substrate; and
forming a substantially transparent film on the substrate.

22. The process of claim 21, wherein the substrate is a wood-based article.

23. The process of claim 21, wherein the substrate is a surface of an automobile.
